(19) United States
(12) Patent Application Publication
(10) Pub. No.: US 2009/0010013 A1
(43) Pub. Date: Jan. 8, 2009

(54) Light for a vehicle, particularly flash warning light for an aircraft

(76) Inventor: Andre Hessling, Vallendar (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/166,717

(22) Filed: Jul. 2, 2008

Related U.S. Application Data
(60) Provisional application No. 60/947,587, filed on Jul. 2, 2007.

(51) Int. Cl. B64D 47/02

(52) U.S. Cl. 362/470

(57) ABSTRACT

The light for a vehicle, particularly a flash warning light for an aircraft, is provided with at least one LED (10) bearing a semiconductor chip (14) emitting electromagnetic radiation. The semiconductor chip (14) emits blue or UV light. A conversion material (18) is arranged in the beam path that is permeable to low-energy radiation portions of the emitted light and is partly permeable to high-energy radiation portions of the emitted light, wherein a part of the high-energy radiation portions of the emitted light can be converted into low-energy radiation portions by the conversion material (18) The part of the high-energy radiation of the emitted light that penetrates the conversion material (18) is limited by means of an optical element and can partly be used again to increase efficiency.

The invention refers to a light for a vehicle and in particular to a flash warning light for an aircraft.

Red lights or lights emitting in the wavelength range of red light in vehicles and particularly in aircrafts are known per se. Besides a number of beacon lights of different colors and white anti-collision lights, most aircrafts (planes, helicopters or the like) are also provided with red flash warning lights for better visibility in adverse or bad visual conditions. Presently most wide-spread are flash warning lights on the basis of xenon gas discharge lamps.

Since several years, the illuminants of red flash warning lights are made on the basis of LED technology. For red flash warning lights, red LEDs with an AlInGaP semiconductor material is used. LED technology is advantageous over xenon gas discharge lights in that the maintenance effort is reduced and the illuminants have a lower power consumption. The above mentioned LEDs are especially suited for aircrafts since they comply with the specified color “aviation red”.

However, power dissipation is a problem with the above mentioned LEDs. For the required energy densities (relative to the installation space of the lights), the LEDs would have to be driven such that they would destroy themselves thermally. Thus, the LEDs can not be driven with full power, which in turn means that the installation space of the lights has to be enlarged. Moreover, due to their physical structure (material system AlInGaP), the known LEDs degrade reversibly (thermally) and irreversibly at a relatively fast rate. The energy densities and impulse strengths that can be realized with known LEDs are thus so low that, for the same light output as that of a xenon discharge lamp, either the lights become clearly larger or require a very great cooling effort. Both alternatives eventually lead to rather cost-intensive lights.

Furthermore, the low impulse strength of the known red LEDs necessarily makes their flash period relatively long in order to meet the calculated equivalent light output specified by law, which, however, impairs the visibility due to the relatively long flash.

It is an object of the invention to realize an improved red light on LED basis for a vehicle, particularly as a flash warning light for an aircraft.

The invention achieves this object by providing a light for a vehicle, particularly a flash warning light for an aircraft, provided with
at least one LED with a semiconductor chip emitting electromagnetic radiation,
the semiconductor chip emitting energy-rich light (in the visible range, e.g. blue and/or UV radiation),
a conversion material being positioned in the beam path, which is permeable to low-energy radiation portions of the emitted light and partly permeable to high-energy radiation portions of the emitted light, wherein a part of the high-energy radiation portions of the emitted light can be converted into low-energy radiation portions by the conversion material, and
the part of the high-energy radiation of the emitted light permeating the conversion material can be attenuated by an optical damping element.

According to the invention, an LED technology is employed in the generation of red light, which first covers substantially the entire spectrum of visible light. In the beam path of the radiation emitted from the chips thereof, a conversion material (e.g. based on phosphor) is situated that is penetrated and excited in particular by the high-energy radiation portion of the light emitted by the LEDs. A part of this radiation portion is converted into low-energy radiation portions by the conversion material so that, overall, a white or amber-white light is obtained. However, this light does not yet meet the requirements of “aviation red”, since a part of the high-energy radiation passes through the conversion material and emerges therefrom without being converted into low-energy radiation and a part of the radiation emitted by the excitation is situated above the red range. According to the invention, this portion of the high-energy radiation is attenuated by means of an optical damping element or is ideally blocked completely. This is achieved, for example, with a color filter that does not pass light above a certain limit frequency or below a predefined wavelength, i.e. blocks short-wave high-energy light. A dichroitic mirror is particularly advantageous as an optical damping element, the mirror reflecting the short-wave high-energy light back to the conversion material where it contributes to the excitation of further low-energy radiation portions. This allows for an optimization of the exploitation of the conversion capacity of the conversion material.

Thus, the actual idea of the invention is to use an illuminant that is rather atypical for the present application (red light or red flash light), namely a LED emitting substantially in the entire range of visible light, which LED has the advantage of a high power rating so as to transform the spectrum emitted by this LED such that it precisely meets the color requirements of the application.

A LED semiconductor material particularly suited for the invention is InGaN, since this material has a high current-carrying capacity, is thermally uncritical and non-ageing. Such a semiconductor material is presently already used in blue and UV-LEDs. This semiconductor material allows for shorter flash periods and thus for a better visibility, while simultaneously allowing for a smaller installation space and lower cooling efforts; all of these criteria correspond or meet the present customer demands (aircraft manufacturers and airlines).

According to the invention, the nearly monochromatic light of short wave-lengths of the InGaN semiconductor material has to be converted. This principle of conversion is basically known from white LEDs. In these white LEDs, high-energy blue light or also UV light excites a conversion material (mostly based on phosphor) which then emits yellow light, i.e. light of lower energy (equivalent to a higher wavelength or a lower frequency). The sum of the blue and yellow light yields a white impression (which is on the connection line of the individual colors in the CIE diagram).

Conversion materials exist that emit a wide spectrum with low-energy light. This light is considered very “warm” and in some cases corresponds to the official regulations for the color location used for vehicle direction lights.

Red light, as officially provided for the application “aviation red”, can not be realized technically in the same manner alone. The conversion material must be at least partly permeable to high-energy (e.g. blue light), since otherwise the light beam will not even meet excitable electrons of the atoms of the conversion material. Thus, high-energy color portions also naturally always exist that penetrate the conversion material and are therefore located in the spectrum of the emitted light. However, the mixed color of the entire emitted wavelength spectrum is a light which per se does not satisfy the regulations regarding color saturation and color location for “red” in the field of aircraft construction or terrestrial vehicles.

If, however, as provided by the invention, the parasitic frequencies are blocked after the conversion of the major part of the radiation in the visible light, an efficient LED light source is obtained that clearly enlarges the performance range of present red LED flash warning lights (or also braking lights of vehicles). In the simplest case, the high-energy radiation portions that penetrate the conversion material or are excited are blocked by a low-pass color filter blocking the energy-rich radiation beyond an upper limit frequency and thus shifts the color emphasis to red.

Suited even better than a filter is a dichroitic mirror material that reflects undesired high-energy (blue) portions back to the conversion material where they can be used the excite the desired warm colors of light (low-energy light), whereby the efficiency of the LED is significantly increased.

In practice, coating conventional LEDs (blue or UV LEDs with conversion material) with a dichroitic mirror layer would already be suitable to fulfill the purposes of the invention. However, other embodiments are conceivable, if they are reasonably adapted to the geometry of the illuminant, so that the largest possible portion of undesired high-energy radiation in the visible wavelength range can be utilized for further conversion into low-energy light.

The following is a detailed description of the invention with reference to the drawings. In the Figures:

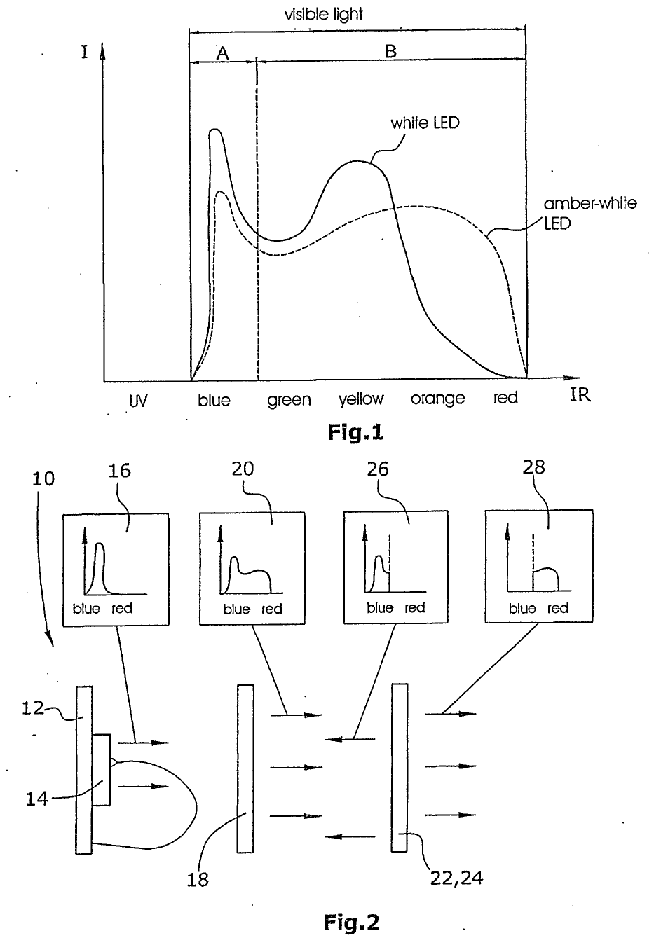

FIG. 1 illustrates the spectrum of a white or amber-colored LED on InGaN semiconductor basis,

FIG. 2 is a schematic diagram to illustrate the individual components of the red light according to the invention,

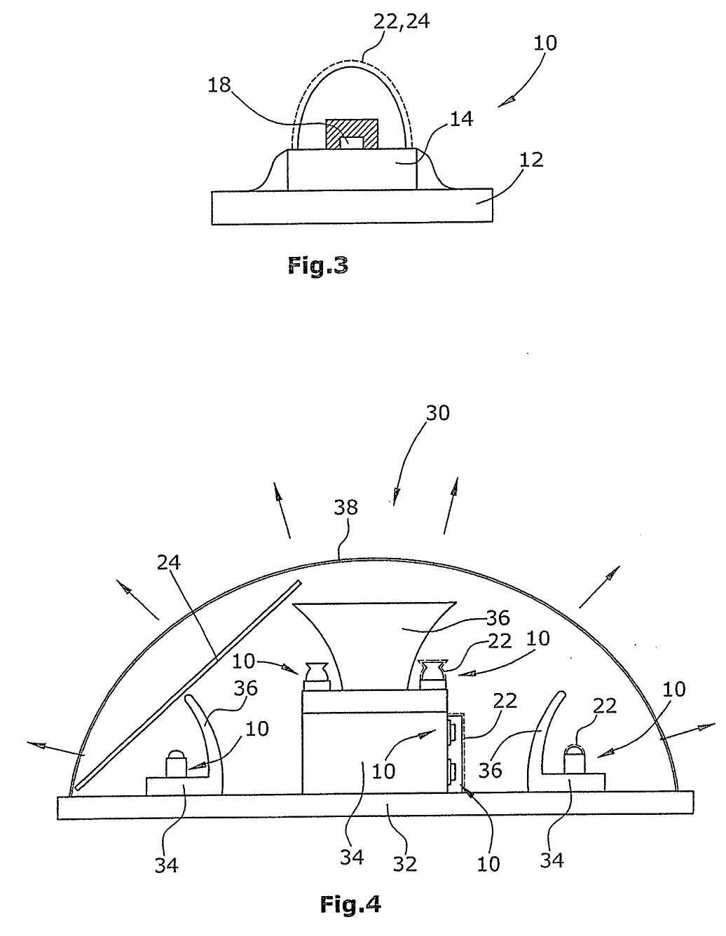

FIG. 3 illustrates a functional principle and an embodiment of a LED useful in the invention, and

FIG. 4 illustrates an example for a flash red warning light on the basis of white/amber-white LEDs and dichroitic mirrors or low-pass color filters.

FIG. 1 illustrates the spectrum (intensity over wavelength) of the visible light emitted by a white or amber-white LED. The LED includes a InGaN semiconductor material. These LEDs are provided with a conversion material, mostly based on phosphor, which converts blue or UV radiation portions into high-energy radiation portions.

When it is desired to use such an LED technology to generate red light that would meet the requirements set by “aviation red”, it will be found that the blue radiation portion A is interfering, since only the remaining radiation portion B within the visible light emitted by the InGaN LEDs can be utilized for the generation of red light.

FIG. 2 shows how to successfully utilize the conventional InGaN LED 10, which originally emits blue or UV light, to generate red light. The LED 10 comprises a carrier substrate 12 onto which an InGaN chip 14 is applied that emits blue light (see the spectrum shown at 16 in FIG. 2). The blue light penetrates a phosphor penetration material 18 that converts the major part of the blue light into low-energy light, i.e. light “along the lines of red”. Behind the conversion material, a radiation spectrum is thus obtained as illustrated in FIG. 2 at 20.

Unfortunately, this spectrum is not suitable for “aviation red” since the portion of blue light is still too large. This s due to the fact that the conversion material is unfortunately penetrated by a part of the blue light without this light being color converted.

In this embodiment, a dichroitic mirror 22 and/or a filter 24 are arranged in the beam path downstream of the conversion material 18, which block light with a wavelength above a limit frequency G. When a dichroitic mirror 22 is used, the blocked light can be reflected back towards the conversion material 18 (see the diagram at 26 in FIG. 2), where it may be utilized to further excite low-energy light (increase in the efficiency of the utilization of the conversion material). When a color filter 24 is used, the blue light is ideally absorbed completely, so that, similar to the utilization of a dichroitic mirror 22, a radiation spectrum is obtained behind the filter 24 as illustrated in FIG. 2 at 28. This spectrum now meets the requirements of “aviation red”, for example.

FIG. 3 illustrates a possible technical realization of the LED 10. The conversion material 18 is provided on the InGaN chip 14. On the outside of the “LED optic” (transparent material), a dichroitic mirror layer or a color filter layer is provided that correspond/-s to the dichroitic mirror 22 or the filter 24 of FIG. 2.

FIG. 4 shows a possible realization of a red flash warning light 30 on the basis of white/amber-white LEDs 10 with an InGaN chip 14 and dichroitic mirrors 22 or low-pass color filters 24, respectively. The flash warning light 30 comprises a carrier 32 that is provided, for example, with a plurality of structural elements 34 carrying LEDs 10. These LEDs 10 are both LEDs emitting upward and LEDs emitting sideward. Reflectors 36 are arranged on the structural elements 34. Around the LEDs 10, either dichroitic mirror layers 22 are situated or the red flash warning light 30 comprises a low-pass color filter 24 penetrated by the light of several LEDs. Such an arrangement of a dichroitic mirror material for several LEDs 10 is also possible and is illustrated in FIG. 4. All LEDs 10, structural elements 34 and color filters 24 as well as dichroitic mirror layers 22 are covered by a cap 38 (also referred to as a light disc) permeable to visible light.

1. A light for a vehicle, particularly a flash warning light for an aircraft, comprising
at least one LED (10) with a semiconductor chip (14) emitting electromagnetic radiation,
characterized in that
the semiconductor chip (14) emits visible light and/or UV radia-tion,
a conversion material (18) is positioned in the beam path, which is partly permeable to the emitted and converted light, wherein a part of the high-energy radiation portions of the emitted light can be converted into low-energy radiation portions by the conversion material (18), and
the part of the high-energy radiation of the emitted light perme-ating the conversion material (18) can be attenuated by an opti-cal damping element.

2. The light of claim 1, characterized in that the semiconductor chip (14) comprises InGaN as the semiconductor material and that the conversion material (18) comprises phosphor.

3. The light of claim 1, characterized in that the optical damping ele-ment is a low-pass color filter (24) that is permeable to radiation por-tions above a predetermined wavelength.

4. The light of claim 1, characterized in that the optical damping ele-ment is a dichroitic mirror (22) that reflects radiation portions up to a limit wavelength towards the conversion material (18) so as to utilize these radiation portions for conversion into low-energy radiation por-tions.
